(19) United States
(12) Patent Application Publication
(10) Pub. No.: US 2012/0185892 A1
(43) Pub. Date: Jul. 19, 2012

(54) SYSTEM AND METHOD FOR MANAGING MULTIPLE CONTENT CHANNELS AND ENGAGEMENT SCORING

(75) Inventors: Doug Camplejohn, San Francisco, CA (US); Dan Chiao, South San Francisco, CA (US)

(73) Assignee: Fliptop, Inc., a corporation of CA

(21) Appl. No.: 13/009,397

(22) Filed: Jan. 19, 2011

(51) Int. Cl. H04N 7/16

(52) U.S. Cl. 725/27

(57) ABSTRACT

A system and method for managing multiple content channels and engagement scoring are disclosed. A particular embodiment includes providing, by use of a data processor, a user interface to enable a user to specify a plurality of channels of interest, the user interface further enabling the user to provide authentication credentials for each channel of the plurality of channels of interest; using the authentication credentials to automatically collect channel data from each of the plurality of channels of interest, the channel data including posts data, subscriber data, and subscriber activity data from each channel; augmenting the channel data with data collected from other content sources; processing the augmented channel data to produce an engagement score, the engagement score representing a degree to which a plurality of subscribers are involved in subscriber activity at the plurality of channels of interest; and presenting at least a portion of the processed augmented channel data and the engagement score to the user in one or more reports.

### TECHNICAL FIELD

This application relates to a method and system for use with networked content sources, according to one embodiment, and more specifically, for managing multiple content channels and engagement scoring.

### BACKGROUND

The content available to networked computer users has increased significantly in recent years. Providers of such content include blogs, news sources, sports sources, weather sources, libraries, friends, universities, businesses, or any of a variety of providers of network transportable digital content. Various content sources enable a user to subscribe to a content provider's website, or the like, and receive a content channel in a defined format.

Some content sources can be subscription-based or user-identity-based and may generate large numbers of content followers or users of a particular content source (denoted herein as subscribers). These content followers or subscribers can form communities or social networks around a particular content source or content distribution system. Social networks have gained in popularity as people have used content sources and content itself as a basis for connecting with each other. Various conventional sites, such as facebook.com, twitter.com, and youtube.com are just a few examples of the content sources and social networks that have grown in popularity.

As the numbers and size of the content sources and social networks expand, it becomes more difficult to track the subscriber demographics of the involved users and the degree to which the users are involved with the content. Similarly, it becomes more difficult to identify and rank the most popular content items being consumed across a variety of content sources and social networks.

Thus, a system and method for managing multiple content channels and engagement scoring are needed.

### BRIEF DESCRIPTION OF THE DRAWINGS

The various embodiments is illustrated by way of example, and not by way of limitation, in the figures of the accompanying drawings in which:

FIG. 1 illustrates an example embodiment of a system and method for managing multiple content channels and engagement scoring;

FIG. 2 illustrates a detail of the channel data acquisition module in an example embodiment;

FIG. 3 illustrates detail of the channel data processing module of an example embodiment;

FIG. 4 illustrates the user services module of a particular embodiment;

FIG. 5 illustrates the extended subscriber data acquisition module of a particular embodiment;

FIG. 6 illustrates the targeted advertising module of a particular embodiment;

FIGS. 7-15 illustrate example display screen snapshots of a particular embodiment;

FIG. 16 illustrates another example embodiment of a networked system in which various embodiments may operate;

FIG. 17 is a processing flow chart illustrating an example embodiment of a content channel management system as described herein;

FIG. 18 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

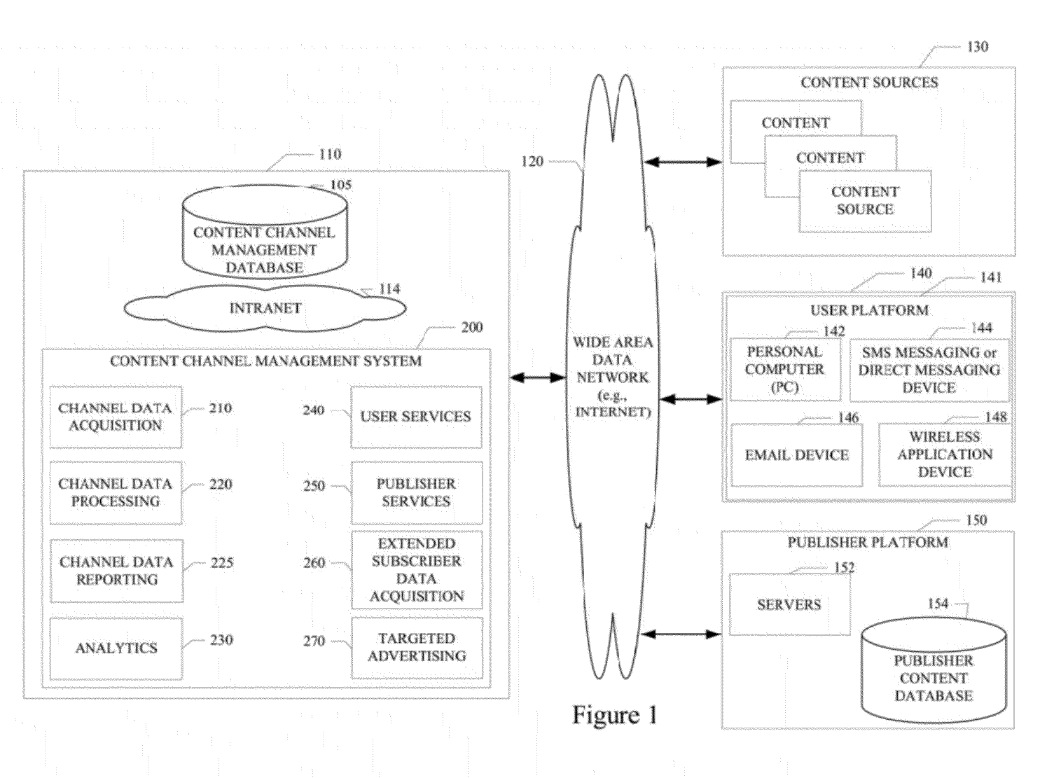

Referring to FIG. 1, in an example embodiment, a system and method for managing multiple content channels and engagement scoring are disclosed. In various example embodiments, an application or service, typically operating on a host site (e.g., a website) 110, is provided to simplify and facilitate content channel management and engagement scoring for a user at a user platform 140 from the host site 110. The host site 110 can thereby be considered a content channel management site 110 as described herein. Multiple content sources 130 provide a plurality of content channels of which a user may become a content consumer and/or a content provider. Various conventional sites, such as facebook.com, twitter.com, and youtube.com are just a few examples of the available content sources 130. One or more of the content channels can be provided by one or more content publishers operating at publisher platforms 150. It will be apparent to those of ordinary skill in the art that content sources 130 can be any of a variety of networked content providers, email marketing services, social network sources, or content aggregators as described in more detail below. For example, content sources 130 can include social media channels, such as Facebook, Twitter, or YouTube, or email marketing sites, such as MailChimp, Constant Contact, or ExactTarget. The content channel management site 110, content sources 130, user platforms 140, and publisher platforms 150 may communicate and transfer content and information via a wide area data network (e.g., the Internet) 120. Various components of the content channel management site 110 can also communicate internally via a conventional intranet or local area network (LAN) 114.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital User Lines (DSLs), wireless links including satellite links, or other communication links known to those of ordinary skill in the art. Furthermore, remote computers and other related electronic devices can be remotely connected to either LANs or WANs via a modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to move freely and randomly and organize themselves arbitrarily, such that the topology of networks 120 and 114 may change rapidly.

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The content sources 130 may include any of a variety of providers of network transportable digital content. Typically, the file format that is employed is XML, however, the various embodiments are not so limited, and other file formats may be used. For example, feed formats other than HTML/XML or formats other than open/standard feed formats can be supported by various embodiments. Any electronic file format, such as Portable Document Format (PDF), audio (e.g., Motion Picture Experts Group Audio Layer 3—MP3, and the like), video (e.g., MP4, and the like), and any proprietary interchange format defined by specific content sites can be supported by the various embodiments described herein. Syndicated content includes, but is not limited to such content as news feeds, events listings, news stories, blog content, headlines, project updates, excerpts from discussion forums, business or government information, and the like. As used throughout this application, including the claims, the term “feed,” sometimes called a channel, refers to any mechanism that enables content access from a content source 130. Thus, as used herein, a feed mechanism may include a push mechanism, a pull mechanism, a download mechanism, a streaming mechanism, a polling mechanism, or other content access mechanism. In one embodiment, a feed may represent an aggregation of content formatted in a format available for access. Moreover, a content source 130 may provide more than one feed.

In a particular embodiment, a user platform 140 with one or more client devices 141 enables a user to access content from the content sources 130 via the network 120. Client devices 141 may include virtually any computing device that is configured to send and receive information over a network, such as network 120. Such client devices 141 may include portable devices 144 or 146 such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. Client devices 141 may also include other computing devices, such as personal computers 142, multiprocessor systems, microprocessor-based or programmable consumer electronics, network PC's, and the like. As such, client devices 141 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message.

Client devices 141 may also include at least one client application that is configured to receive content or messages from another computing device via a network transmission. The client application may include a capability to provide and receive textual content, graphical content, video content, audio content, alerts, messages, notifications, and the like. Moreover, client devices 141 may be further configured to communicate and/or receive a message, such as through a Short Message Service (SMS), direct messaging (e.g., Twitter), email, Multimedia Message Service (MMS), instant messaging (IM), internet relay chat (IRC), mIRC, Jabber, Enhanced Messaging Service (EMS), text messaging, Smart Messaging, Over the Air (OTA) messaging, or the like, between another computing device, and the like.

Client devices 141 may also include a wireless application device 148 on which a client application is configured to enable a user of the device to subscribe to at least one content source 130. Such subscription enables the user at user platform 140 to receive through the client device 141 at least a portion of the content. Such content may include, but is not limited to, instant messages, Twitter tweets, posts, stock feeds, news articles, personal advertisements, shopping list prices, images, search results, blogs, sports, weather reports, or the like. Moreover, the content may be provided to client devices 141 using any of a variety of delivery mechanisms, including IM, SMS, Twitter, Facebook, MMS, IRC, EMS, audio messages, HTML, email, or another messaging application. In a particular embodiment, the application executable code used for content subscription as described herein can itself be downloaded to the wireless application device 148 via network 120.

In some cases, a user at user platform 140 can subscribe to certain content and/or content channels provided by all mechanisms available on the client device(s) 141. In various embodiments described in more detail below, the host site 110 can employ processed information to deliver content channel information to the user using a variety of delivery mechanisms. For example, content channel information can be delivered to a user via email, Short Message Service (SMS), wireless applications, and direct messaging (e.g., Twitter) to name a few. Additionally, content channel information can be provided to a user in response to a

The publisher platform 150 represents a particular content provider, which may be any one of the content sources 130. One or more of the content channels provided by one or more content sources 130 can operate as publisher platform 150. A publisher platform 150 can augment an item of content to provide functionality with which a user at user platform 140 can automatically subscribe to the item of content with a single-click user action. This beneficial functionality simplifies the content subscription process. As with any of the content sources 130, publisher platform 150 can include a data storage device or database of publisher content 154 and one or more servers 152 to serve that content to users at user platforms 140 via network 120.

Referring still to FIG. 1, host site 110 of an example embodiment is shown to include a content channel management system 200, intranet 114, and content channel management database 105. Content channel management system 200 includes channel data acquisition module 210, channel data processing module 220, channel data reporting module 225, analytics module 230, user services module 240, publisher services module 250, extended subscriber data acquisition module 260, and targeted advertising module 270. Each of these modules can be implemented as software components executing within an executable environment of content channel management system 200 operating on host site 110. Each of these modules of an example embodiment is described in more detail below in connection with the figures provided herein.

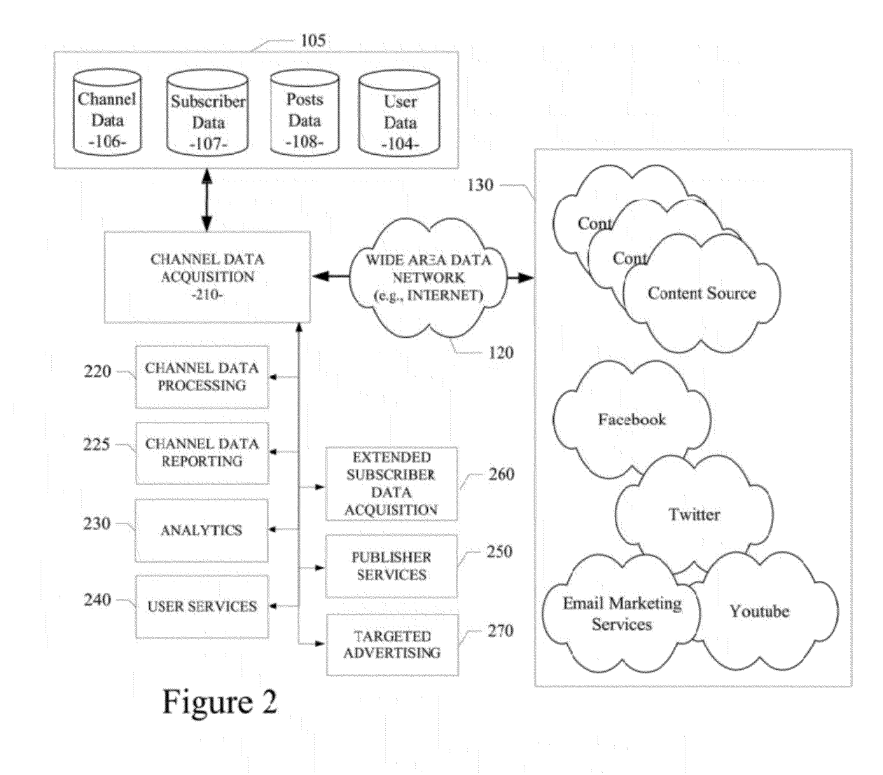

Referring now to FIG. 2, a detail of the channel data acquisition module 210 in an example embodiment is illustrated. As shown, channel data acquisition module 210 is in data communication with a plurality of content sources 130, one or more portions of data storage device 105, and the other processing modules 220 through 270 of the content channel management system 200. In general, the channel data acquisition module 210 is responsible for enabling a user to configure a set of content channels of interest, from which content channel data is collected from a variety of content sources 130. The channel data acquisition module 210 can also be considered a web front end module that can interact with users via a graphical user interface and with content sources via application programming interfaces (API's) as described in more detail below.

In a particular embodiment, channel data acquisition module 210 can be configured to interface with any of the content sources 130 via wide area data network 120. Because of the variety of content sources 130 providing content channels to channel data acquisition module 210, the channel data acquisition module 210 needs to manage each channel. This channel management process includes retaining information on each channel, including an identifier or address of the corresponding content source, the timing associated with the channel, including the time when the latest content update was received and the time when the next update is expected, and the like. This channel information can be stored in channel database 106.

The channel management process also includes determining/obtaining and retaining: 1] the authentication credentials for the content channels that are configured for particular users (stored in user data 104), 2] the identities and data associated with subscribers who have subscribed to a particular content channel (stored in subscriber data 107), and 3] data associated with particular content items (also denoted posts) that were posted or published on particular content channels to which the subscribers have subscribed (stored in posts data 107). The channel data acquisition module 210 can access user data 104 to facilitate the selection by the user of the particular content channels of interest to a particular user.

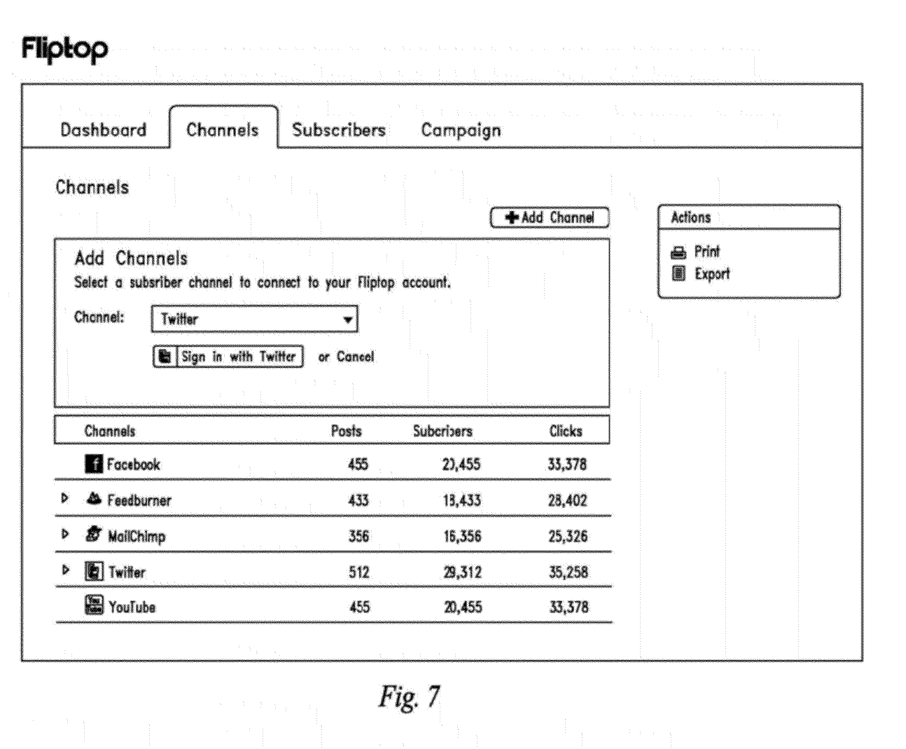

Referring to FIG. 7, a user interface provided by the channel data acquisition module 210 is shown. The user interface shown in FIG. 7 can be used by a user to add a channel of interest to the user's account on host site 110. As shown, a user can add a plurality of channels of interest to the user account. The channel of interest selections can be retained in user data 104. Additionally, when adding each channel through the user interface shown in FIG. 7, the user can also provide the authentication credentials necessary to access the user account on the corresponding content channel. For example, when adding ‘Facebook’ as a content channel of interest, the user would provide the authentication credentials necessary to access the user's Facebook account. These channel authentication credentials can be encrypted and stored in the user data 104. In this manner, a user can manipulate the user interface shown in the example of FIG. 7 to add a plurality of channels of interest to the user account on host site 110. These channels can be social media channels, such as Facebook, Twitter, or YouTube. Additionally, these channels can be email marketing sites, such as MailChimp, Constant Contact, or ExactTarget. Any of a large variety of content sources can be added in this manner. When a new channel and corresponding channel authentication credentials are added to a user account, the channel data acquisition module 210 can notify the channel data processing module 220 that a new content source for the user needs to be processed. This processing performed by the channel

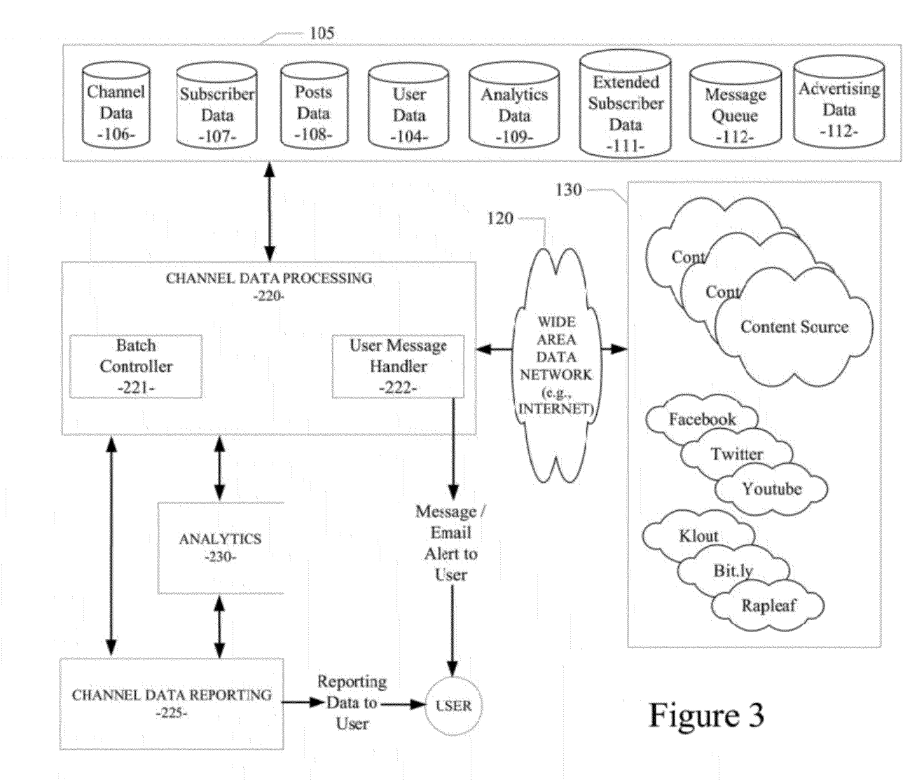

Referring now to FIG. 3, a detail of the channel data processing module 220 of an example embodiment is illustrated. The channel data processing module 220 is responsible for automatically accessing the channels of interest for each user, obtaining data corresponding to each channel, and processing the channel data in ways to make the channel data useful and informative for the user. The channel data processing module 220 of an example embodiment can use a best available web service, such as REST and streaming API's, to download posts, subscriber data, and subscriber activity data from each channel of interest. REST or Representational State Transfer is a conventional style of software architecture for distributed hypermedia systems such as the World Wide Web. The channel data processing module 220 can use a batch controller 221 to collect the channel data in off-line processes. The channel data processing module 220 can also be considered a back end module that can interact with content sources in an off-line mode via application programming interfaces (API's) as described in more detail below.

As shown in FIG. 3, the channel data can be collected from various content sources 130, including Facebook, Twitter, and Youtube, among other sites. The channel data, including posts, subscriber data, and subscriber activity data from each channel, can be collected by the channel data processing module 220 and retained in database 105. In a particular embodiment, the collected posts represent content items posted on the content channel by subscribers. The collected subscriber data can represent the identities and other data related to subscribers who have subscribed to the user's account on the content channel or subscribers who have subscribed to a post or other content item posted through the user's account on the content channel. For example, the collected subscriber data related to the Twitter.com channel can represent all the Twitter subscribers who are followers of the user who has added the Twitter channel to his/her account on the host site 110. The collected subscriber activity data can represent the clicks, click-throughs, ‘likes’, ‘shares’, ‘retweets’, comments, mentions, and the like that are related to input provided by particular subscribers on the corresponding content channel. The posts, subscriber data, and subscriber activity data from each channel can be collected by the channel data processing module 220 using various API's provided by the content channel provider. In addition, related metadata can also be collected. The metadata can be used to merge the identities of persons who are both subscribed to email newsletters, for example, and following on social networks.

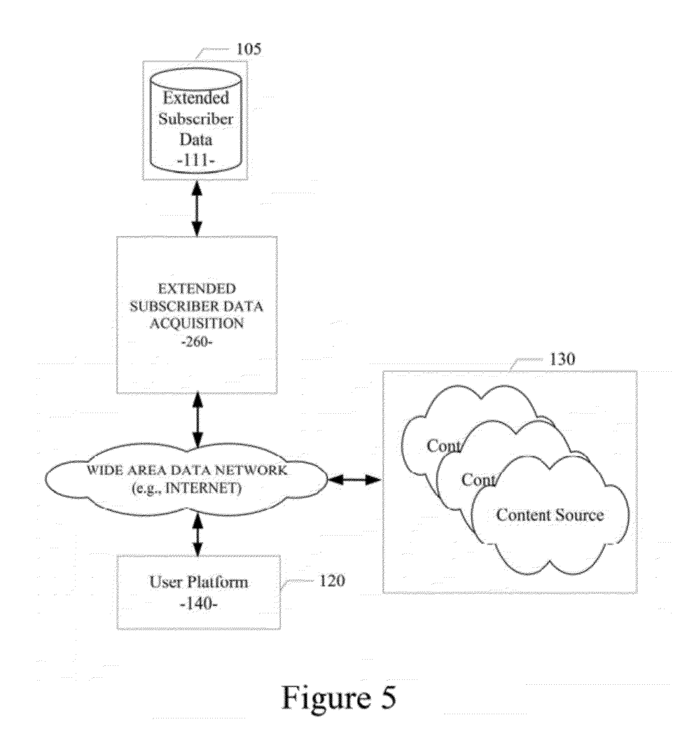

Additionally, the channel data processing module 220 can use various API's to augment the posts, subscriber data, and subscriber activity data collected from each channel. For example, the channel data processing module 220 can use various content sources 130 to obtain augmented channel data including subscriber click data, user influence data, and user demographic or psychographic data from various content sources 130. As shown in FIG. 3, for example, the augmented channel data can be collected from various other content sources 130, including Klout.com, Bit.ly, Rapleaf.com, Ow.ly, Awe.sm, and Qwerly among other sites. In general, the various other content sources 130 can include Uniform Resource Locator (URL) redirection services, direct marketing databases, audience measurement services, and the like. Because the various embodiments can aggregate and analyze such a wide variety of data sources, the various embodiments can merge the online identities of individuals who are using different profiles on different platforms. Additionally, as shown in FIG. 5, the extended subscriber data acquisition module 260 can be used to obtain augmented or extended subscriber data including subscriber profiles, subscriber click data, subscriber influence data, and subscriber demographic or psychographic data from various content sources 130. This augmented channel data and augmented or extended subscriber data can be retained in portions of database 105.

Referring still to FIG. 3, the channel data processing module 220 can use the collected channel data and augmented channel data to generate additional information and metrics of use to the user of host site 110. In particular, the analytics module 230 can be used by the channel data processing module 220 to generate, among other information and metrics, an engagement score related to subscribers, channels, posts, and campaigns. An engagement score represents a generated value or set of values corresponding to a degree to which a subscriber is involved in subscriber activity at a content channel. In one example, the engagement score represents a quantity of actions performed by a particular subscriber at a particular content channel over a given period of time. The actions performed by the particular subscriber can be user clicks, Twitter tweets, Facebook ‘likes’, channel posts, blog entries, comments, messages, and the like. The analytics module 230 can tally up these subscriber actions for each subscriber of a particular channel over a period of time. The particular subscriber with the highest quantity of subscriber actions over the period of time can be considered the subscriber at the high water mark. The particular subscriber with the lowest quantity of subscriber actions over the period of time can be considered the subscriber at the low water mark. The engagement score for each subscriber can be calculated based on the particular subscriber's quantity of actions over the time period relative to the high and low water marks. In one embodiment, the engagement score can be normalized to a scale of 1 to 100, where 1 corresponds to the low water mark and 100 corresponds to the high water mark. In general, the engagement score represents the level to which a particular subscriber is engaged with a particular content channel based on the subscriber's activity level relative to the channel.

In a similar manner, the analytics module 230 can also generate an engagement score that corresponds to the subscriber's aggregated activity level relative to a plurality of channels. Similarly, the analytics module 230 can also generate an engagement score that corresponds to the aggregated subscriber activity level relative to a plurality of subscribers at a single channel or a plurality of subscribers at a plurality of channels. Moreover, the analytics module 230 can also generate an engagement score that corresponds to the aggregated subscriber activity level relative to a particular content item at a particular content channel. In this manner, the generated engagement score can be used to determine how many subscriber actions have been taken relative to a particular post. This information can be used to infer the level of user interest relative to a particular content item. In a similar manner, the analytics module 230 can also generate an engagement score that corresponds to the aggregated subscriber activity level relative to a plurality of particular content items at a particular content channel or to a plurality of particular content items at a plurality of content channels. The analytics module 230 can also generate an engagement score that corresponds to a particular subscriber's activity level relative to a particular content item, a plurality of particular content items at a particular content channel or to a plurality of particular content items at a plurality of content channels. Thus, the analytics module 230 can generate a variety of engagement score that correspond to user activity across multiple subscribers, multiple content channels, and multiple content items. These generated engagement scores can be computed by the analytics module 230 and stored in analytics database 109. The generated engagement scores can also be provided to the channel data processing module 220 and the channel data reporting module 225.

Referring still to FIG. 3, the channel data reporting module 225 is responsible for generating reports, graphs, and other output data to convey information to a user of host site 110. As described above, the channel data acquisition module 210 and the channel data processing module 220 collect and generate data related to content channels, subscribers, subscriber activity, and posts or content items. Additionally, the analytics module 230 generates a set of engagement scores related to channels, subscribers, subscriber activity, and posts. This information, retained in database 105, can be accessed and formatted into various reports, pages, lists, graphics, and the like as requested by a user. FIGS. 7 through 15 provide examples of the kinds of reporting provided by the channel data reporting module 225. For example, the sample channel report of an embodiment illustrated in FIG. 7 shows the set of channels of interest that have been configured for (e.g., added by) a particular user. For each channel of interest, the report shows the total number of posts, subscribers, and clicks associated with the corresponding channel. As described above, the data presented in this sample report was collected and generated by the channel data acquisition module 210 and the channel data processing module 220 based on the data related to the content channel, subscribers, subscriber activity, and posts or content items for each corresponding content channel.

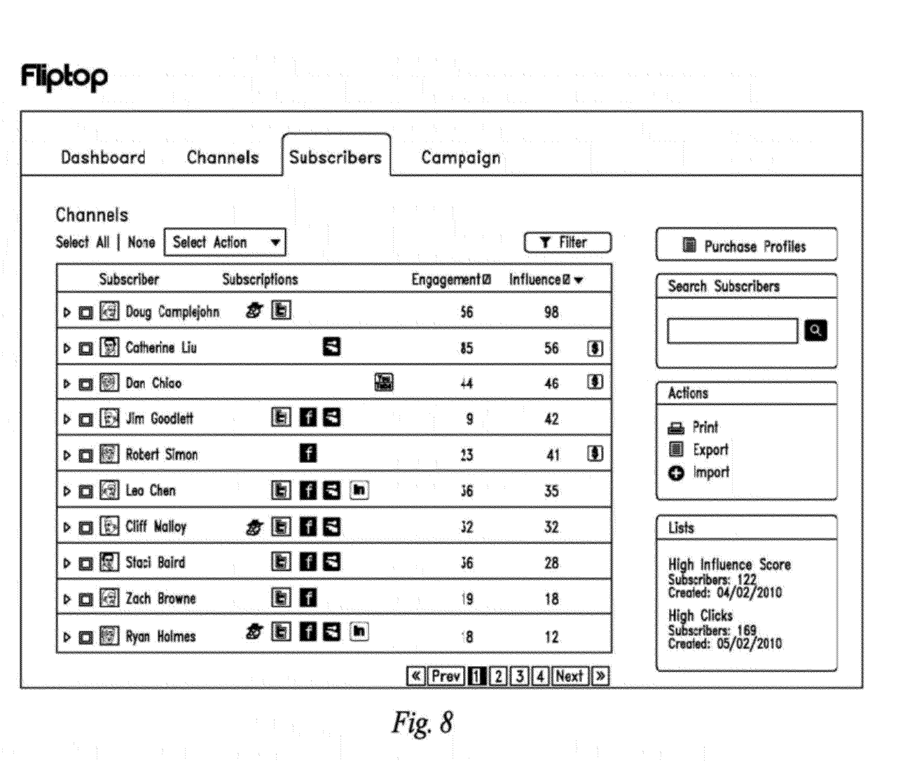

In the sample report of an embodiment illustrated in FIG. 8, the report shows a sample subscriber report. The subscriber report shows the set of subscribers that are associated with each of the channels of interest that have been configured for (e.g., added by) a particular user. For each subscriber, the report shows the channels to which the corresponding subscriber is subscribed. Additionally, for each subscriber, the report shows the engagement score and an influence score. The engagement score is calculated by the analytics module 230 as described above. The influence score is a value obtained from a particular content source (e.g., klout.com). Note that the engagement score is not the same as an influence score. In most cases, these scores will be different values as the scores are generated differently. As described above, the data presented in this sample report was collected and generated by the channel data acquisition module 210, the channel data processing module 220, and the analytics module 230 based on the data related to the content channels, subscribers, subscriber activity, and posts or content items for each corresponding subscriber.

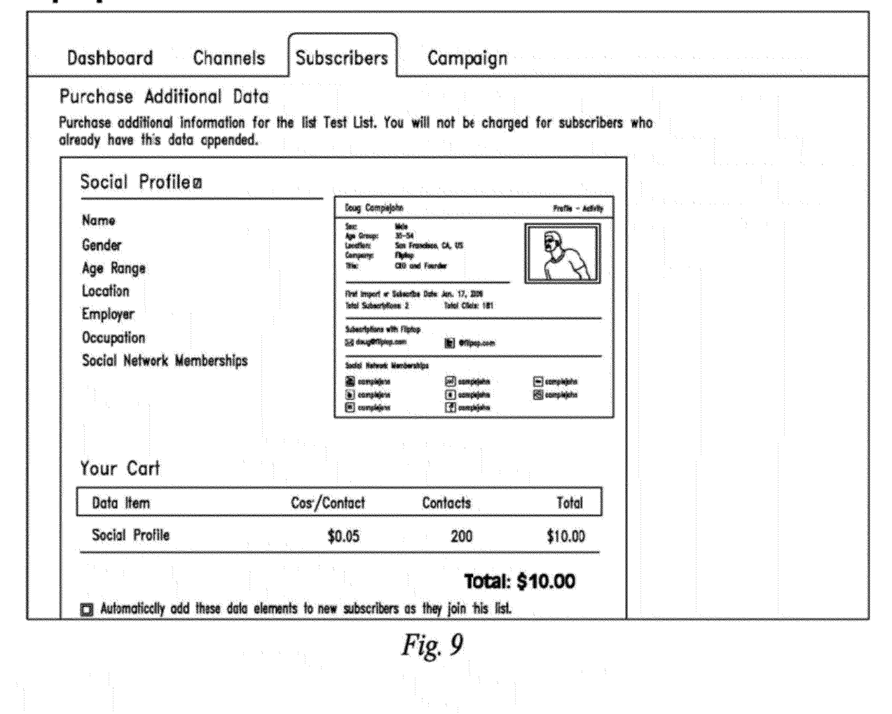

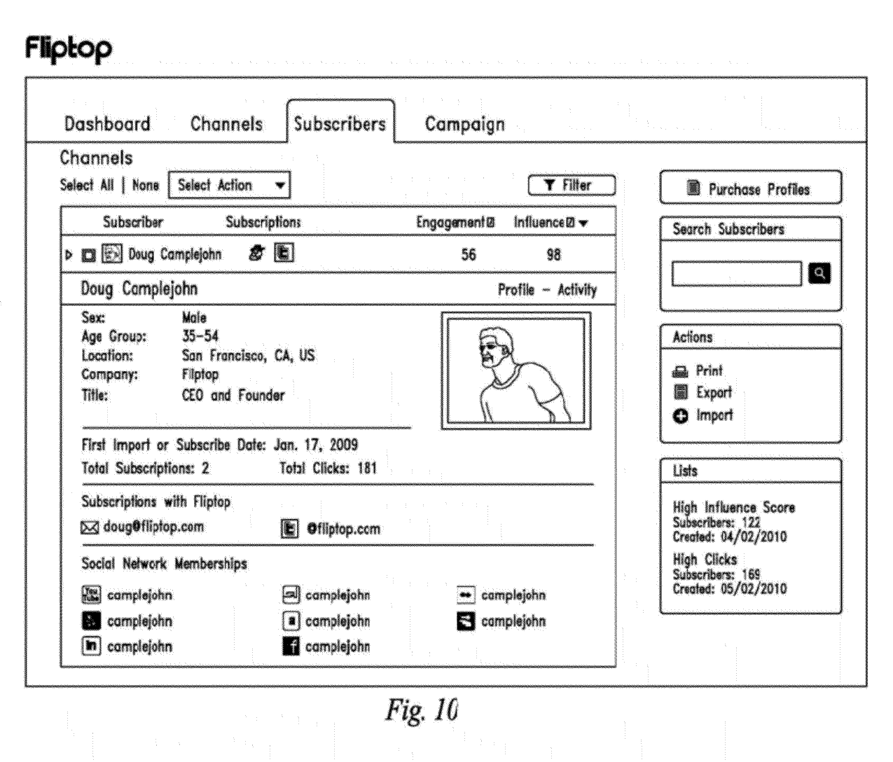

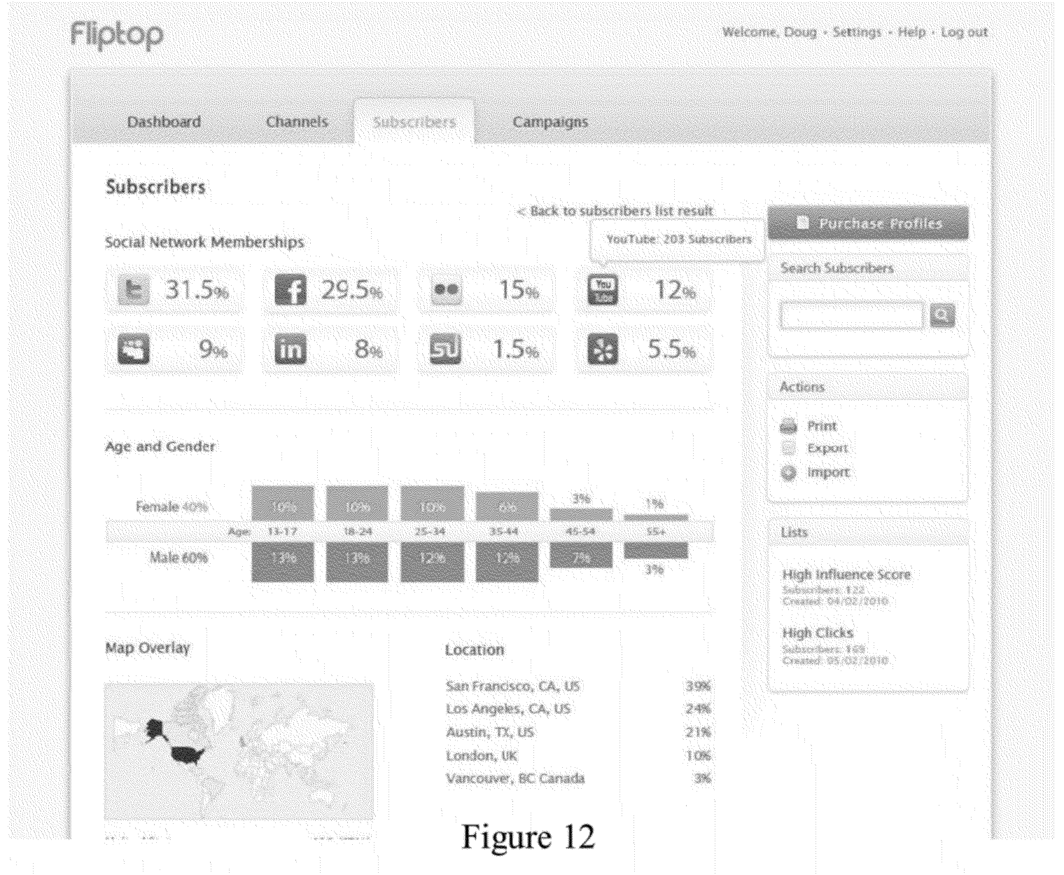

The sample subscriber reports of the embodiments illustrated in FIGS. 9-12 show various extended subscriber reports. The extended subscriber reports can be generated from data obtained by the extended subscriber data acquisition module 260. As described above, the extended subscriber data acquisition module 260 can be used to obtain augmented or extended subscriber data including subscriber profiles, subscriber click data, subscriber influence data, and subscriber demographic or psychographic data from various content sources 130. This subscriber data can be presented to the user in the various subscriber reports shown in FIGS. 9-12. In some cases, the extended subscriber information may require an additional payment by the user as shown in FIG. 9. Additionally, the subscriber data and extended subscriber data can be used to generate additional subscriber information that may be useful to the user. For example, FIG. 10 shows a list of social network memberships corresponding to a particular subscriber. In this manner, the subscriber information for a particular subscriber can span a plurality of content channels. Moreover, as shown in FIG. 12, the social network memberships for a plurality of content channels can be shown in a variety of dimensions including relative size, age/gender breakouts, and geographical location. These reports provide a convenient and useful way for the user to analyze the composition of a plurality of content channels based on the subscriber base.

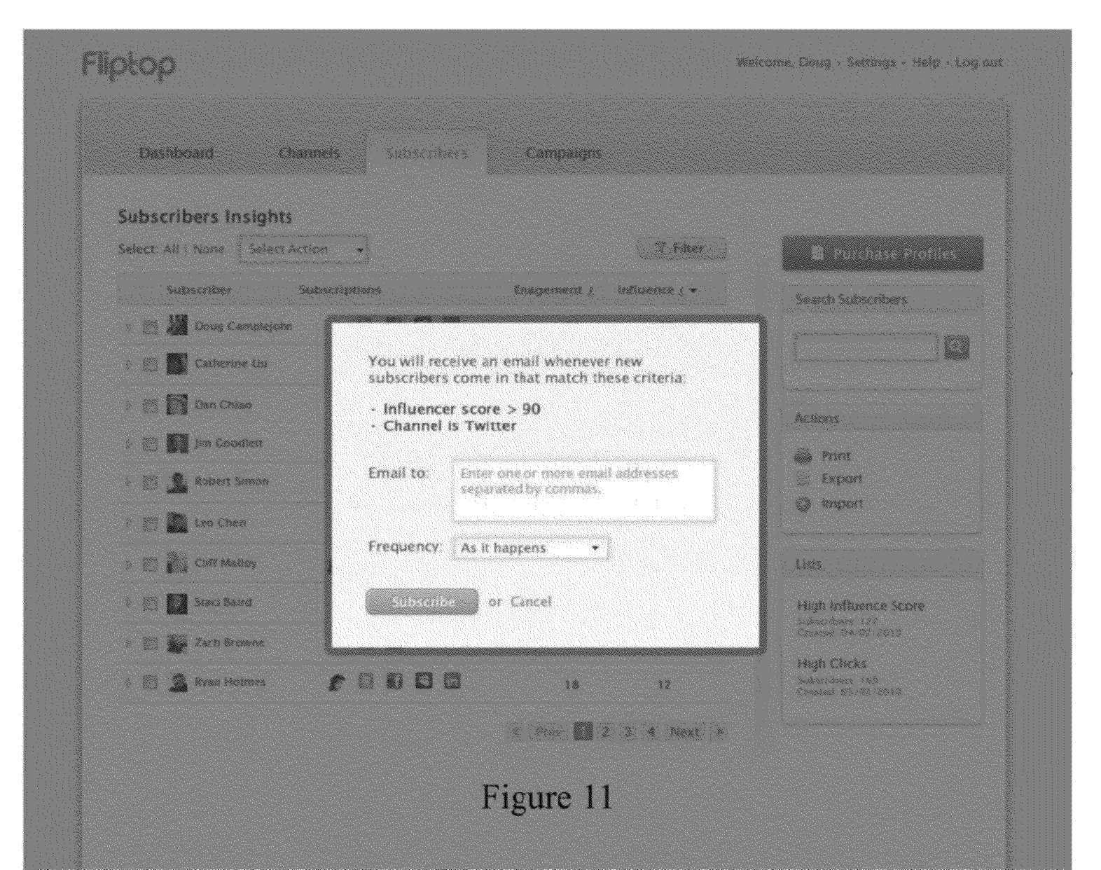

As shown in FIG. 11, a particular embodiment also includes a notification feature that can be configured to cause a notification to be sent to the user when a configurable set of conditions are met. In the example shown in FIG. 11, the user has configured the provided user interface to cause a notification to be sent to the user when a specified influencer score on a specified content channel reaches a specified threshold. It will be apparent to those of ordinary skill in the art that a variety of notification conditions can be configured in a similar manner.

In a particular embodiment, users can manipulate the user interface to optionally specify which of a variety of notification delivery mechanisms the particular user would like to use to receive content channel update notifications. In a particular embodiment, users can select from several notification delivery mechanisms including: email, Short Message Service (SMS), wireless applications, and direct messaging (e.g., Twitter). It will be apparent to those of ordinary skill in the art that these particular messaging mechanisms and any other mechanisms for sending a message or an alert to a computing device, communication device, or entertainment device can similarly be used. As shown in FIG. 3, a user message handler 222 can be configured to send a notification to the user when any of a variety of notification conditions is met. The notification messages to be sent to the user can be queued in message queue 112 of database 105.

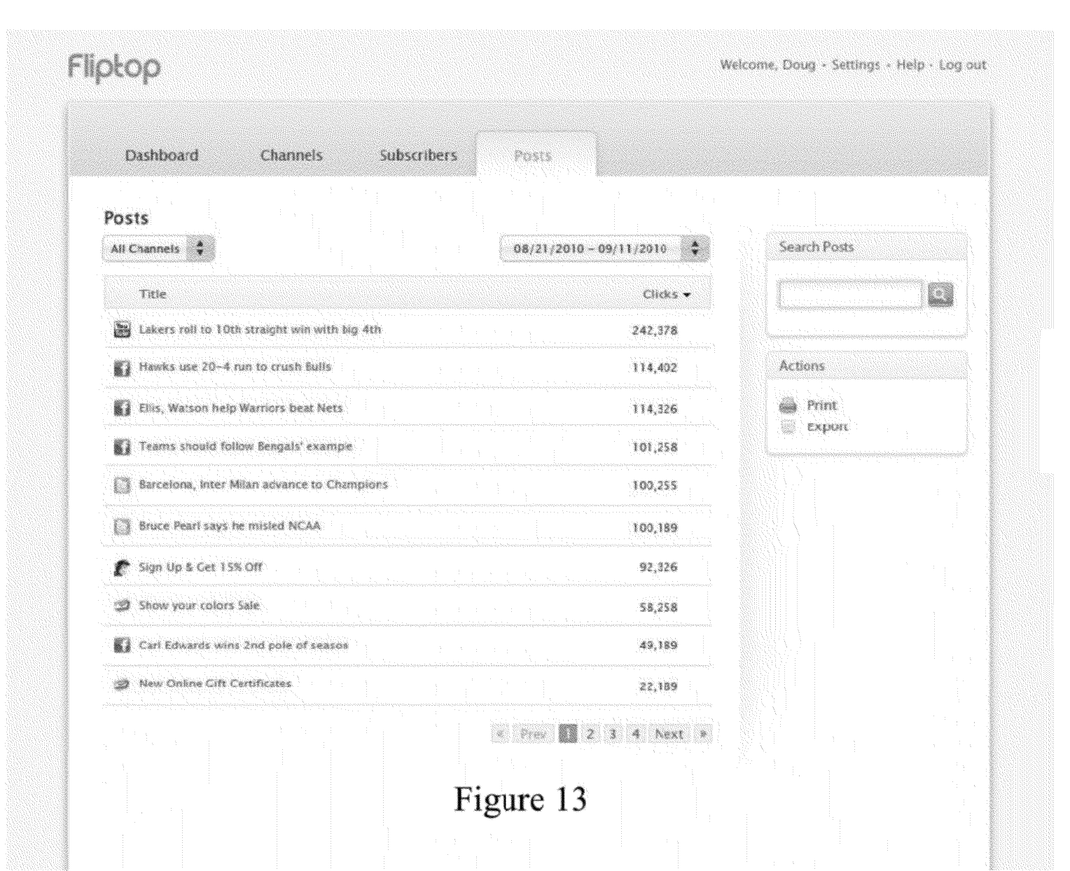

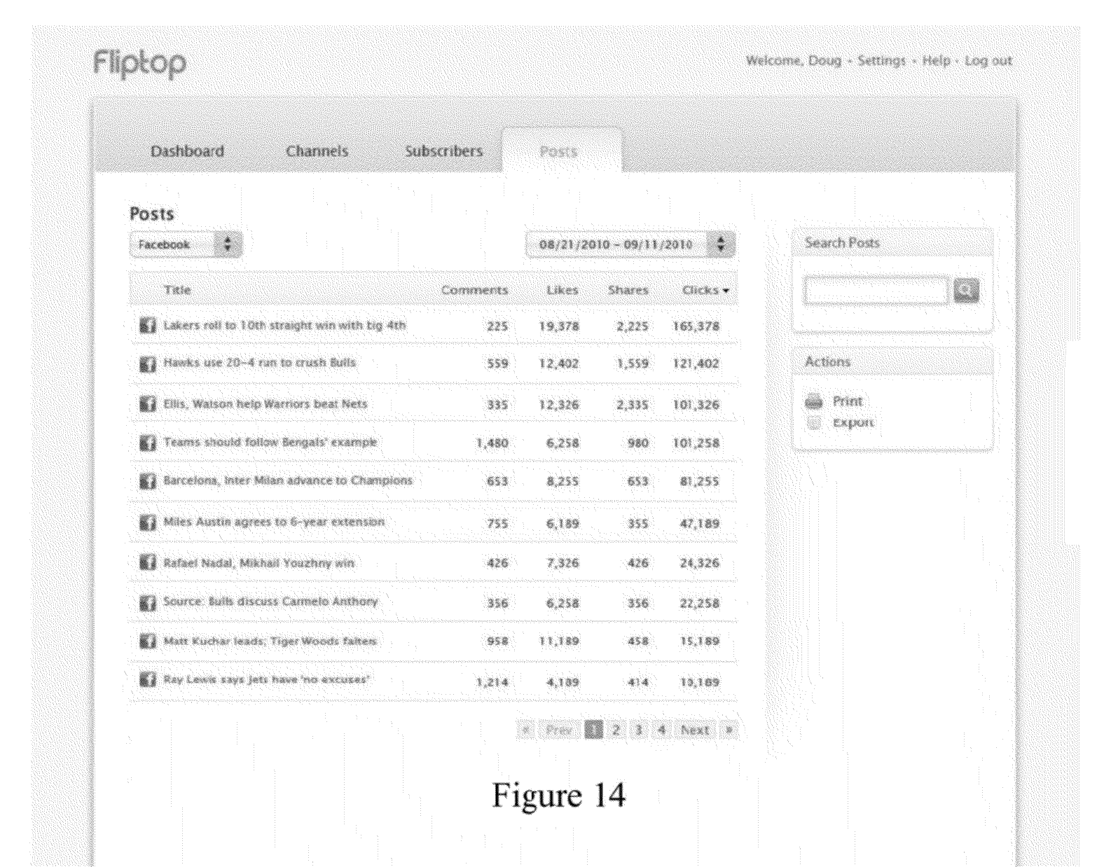

In the sample reports of an embodiment illustrated in FIGS. 13-14, the sample reports show sample posts reports. The posts report shows the set of posts that are associated with each of the channels of interest that have been configured for (e.g., added by) a particular user. For each post, the report shows the title or summary of the post and a value corresponding to the total quantity of subscriber actions (e.g., clicks) taken on the particular post. In the example shown in FIG. 13, the user has selected a view showing all posts from all channels of interest. In this manner, the user can see a collection of posts from a plurality of content channels. Alternatively, the user can select a view corresponding to a particular selected channel. This sample view is shown in FIG. 14. In this manner, the user can focus on a collection of posts from a single selected content channel or a collection of posts from a plurality of content channels. Additionally, the posts reports can be filtered and ranked based on content and/or date ranges.

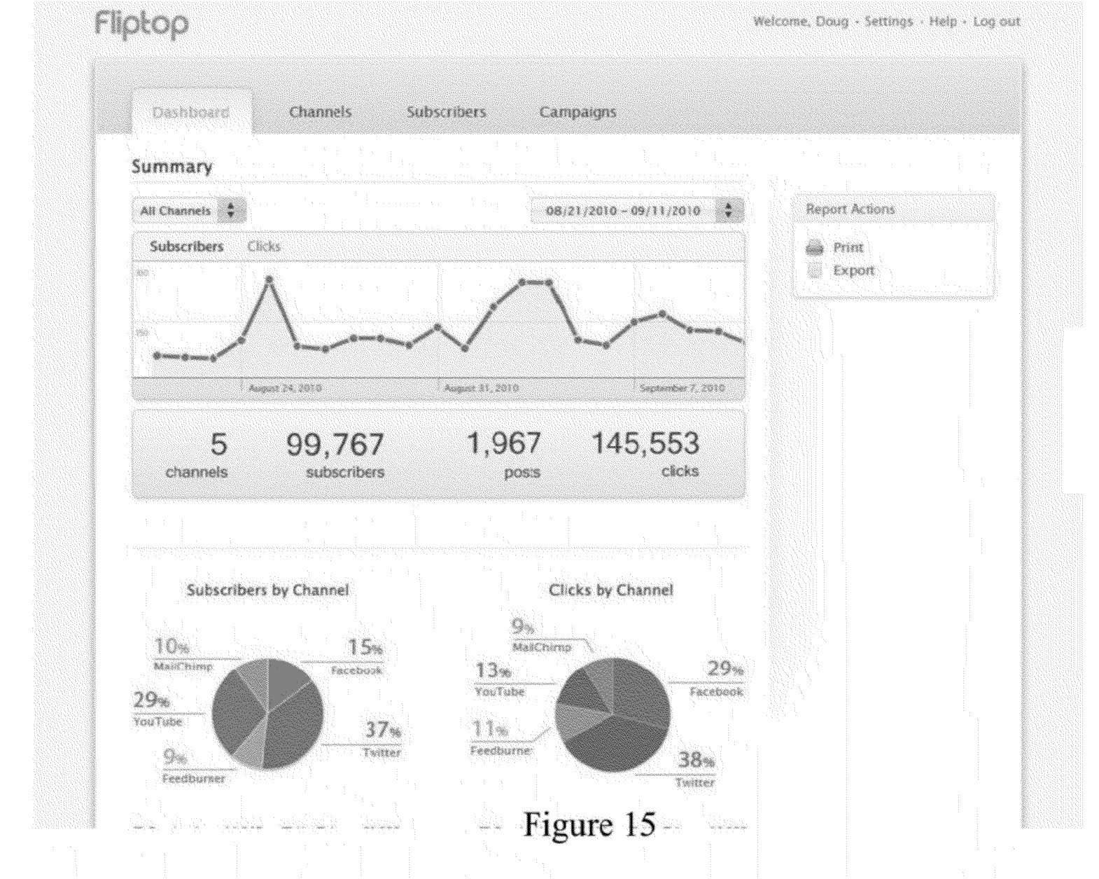

Referring now to FIG. 15, a sample dashboard report shows a summarized collection of channel information, subscriber information, and posts information related to a plurality of channels of interest. The dashboard report enables a user to see an aggregated set of information that is collected by channel data acquisition module 210 and processed by the channel data processing module 220 and analytics module 230. In this manner, a user can visualize trends and relative activity across a plurality of content channels. For example, in the sample dashboard report shown in FIG. 15, the processed channel data generated as described above can be used to display a graph showing the subscriber counts and subscriber activity levels over time for a plurality of channels of interest. Additionally, a graph can show the numbers of subscribers per channel or the levels of subscriber activity per channel. It will be apparent to those of ordinary skill in the art that a variety of other data presentation models can be prepared, given the processed channel data generated as described above.

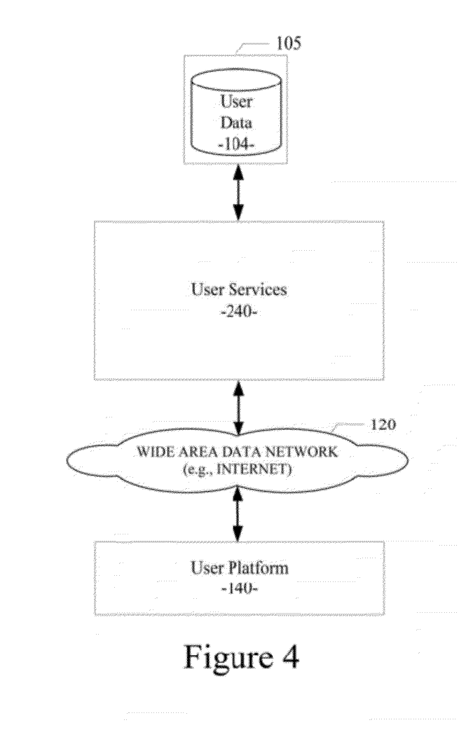

Referring now to FIG. 4, the user services module 240 of a particular embodiment is illustrated. User services module 240 provides the functionality with which a networked computer user operating from a user platform 140 can become a user/member of a content channel management service of host site 110 and interact with the content channel management services provided by the user services module 240. These user content channel management services can be implemented by several functional components provided by the user services module 240. In an example embodiment, these functional components can include a user account module and a payment module. The user account module can be used to create and maintain a user account on the host site 110. The user account module can also be used to configure user settings, create and maintain a user/user profile on host site 110, and otherwise manage user data and operational parameters on host site 110. The user data and operational parameters can be retained in database 104. The payment module can be used to submit payment for a user account and for enabling various user services.

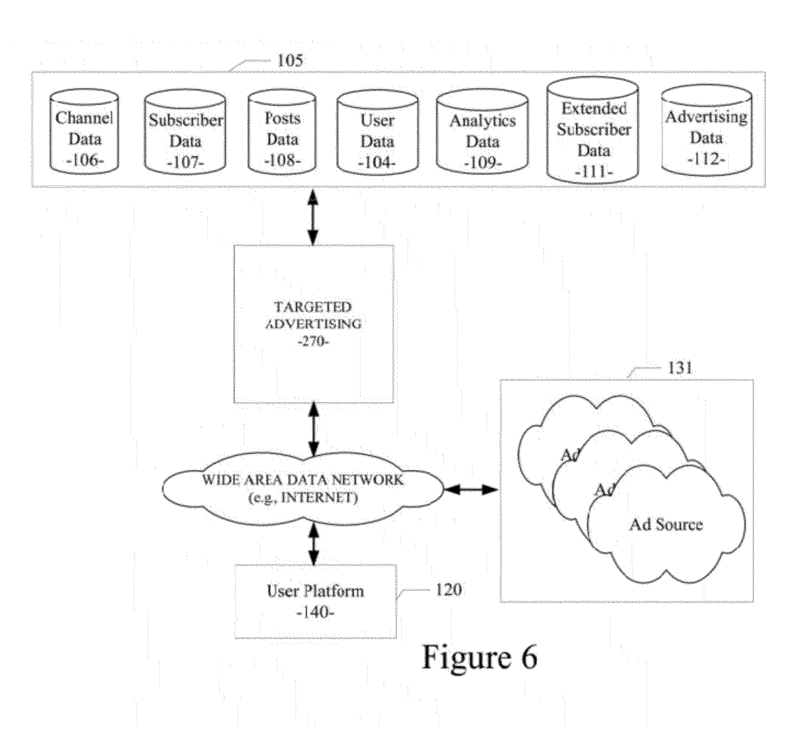

Referring now to FIG. 6, the targeted advertising module 270 of a particular embodiment is illustrated. As described above, various dimensions of data can be collected and generated by the channel data acquisition module 210, the channel data processing module 220, and the analytics module 230 based on the data related to the content channels, subscribers, subscriber activity, and posts or content items for each corresponding channel, subscriber, or post. Given the detailed information captured and processed by these modules, the targeted advertising module 270 of a particular embodiment can determine subscriber affinity in a variety of dimensions. For example, the data related to the content channels, subscribers, subscriber activity, and posts can be correlated to determine the types of content in which the subscribers are most interested. These content types can be defined in varying levels of granularity from broad content categories to specific content items. Once these content types for a particular subscriber or channel are determined, corresponding advertising types can be determined. The determined advertising types for a particular subscriber or channel can be used to find particular advertising items (ads) from an inventory of advertising maintained at one or more ad sources 131. These ads can be served to the particular subscriber or channel at various times, such as when the subscriber clicks on a content item that correlates to a particular advertising item. In this manner, the targeted advertising module 270 enables the content channel management system 200 to facilitate targeted advertising to subscribers or channels. In another example embodiment, analytics extracted from/by targeted advertising module 270 can be used to target and optimize online paid advertising on other platforms like Google AdWords and Facebook, for example. Targeted advertising module 270 can provide some automation for this optimization and targeting; so customers can export the analytics from targeted advertising module 270 and apply them accordingly on their own platforms.

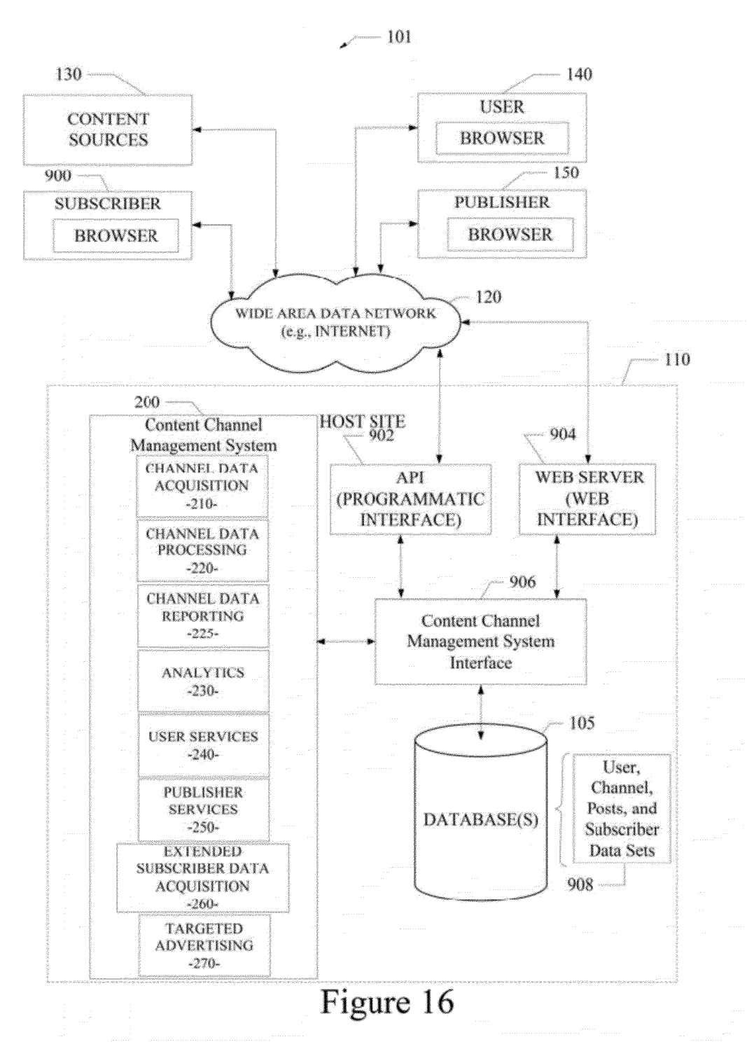

Referring now to FIG. 16, another example embodiment 101 of a networked system in which various embodiments may operate is illustrated. In the embodiment illustrated, the host site 110 is shown to include the content channel management system 200. The content channel management system 200 is shown to include the functional components 210-270. In a particular embodiment, the host site 110 may also include a web server 904, having a web interface with which users may interact with the host site 110 via a user interface or web interface. The host site 110 may also include an application programming interface (API) 902 with which the host site 110 may interact with other network entities on a programmatic or automated data transfer level. The API 902 and web interface 904 may be configured to interact with the content channel management system 200 either directly or via an interface 906. The content channel management system 200 may be configured to access a data storage device 105 either directly or via the interface 906.

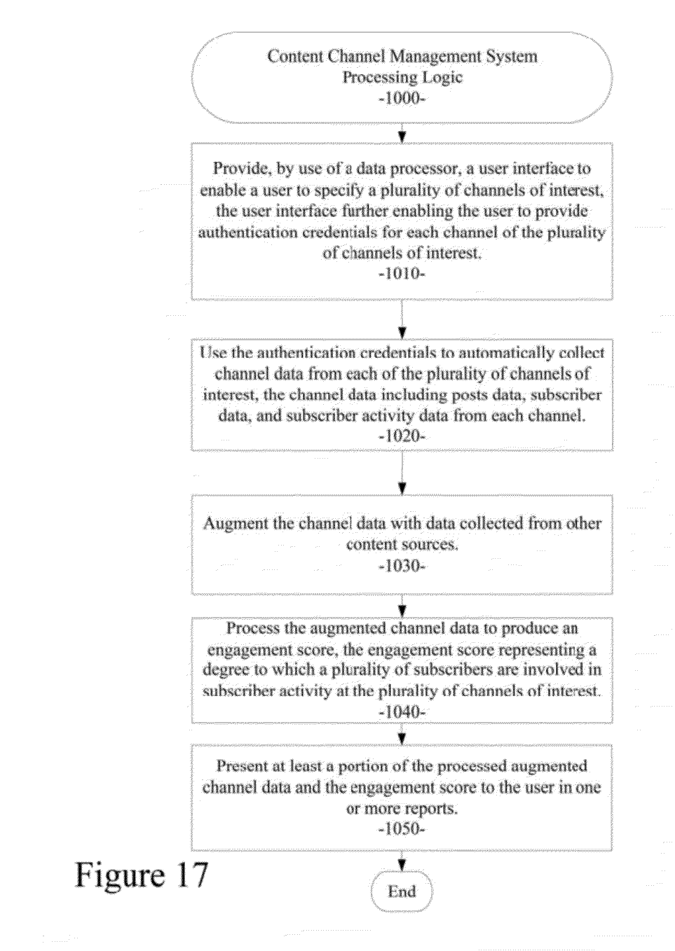

FIG. 17 is a processing flow diagram illustrating an example embodiment of a content channel management system as described herein. The method of an example embodiment includes: providing, by use of a data processor, a user interface to enable a user to specify a plurality of channels of interest, the user interface further enabling the user to provide authentication credentials for each channel of the plurality of channels of interest (processing block 1010); using the authentication credentials to automatically collect channel data from each of the plurality of channels of interest, the channel data including posts data, subscriber data, and subscriber activity data from each channel (processing block 1020); augmenting the channel data with data collected from other content sources (processing block 1030); processing the augmented channel data to produce an engagement score, the engagement score representing a degree to which a plurality of subscribers are involved in subscriber activity at the plurality of channels of interest (processing block 1040); and presenting at least a portion of the processed augmented channel data and the engagement score to the user in one or more reports (processing block 1050).

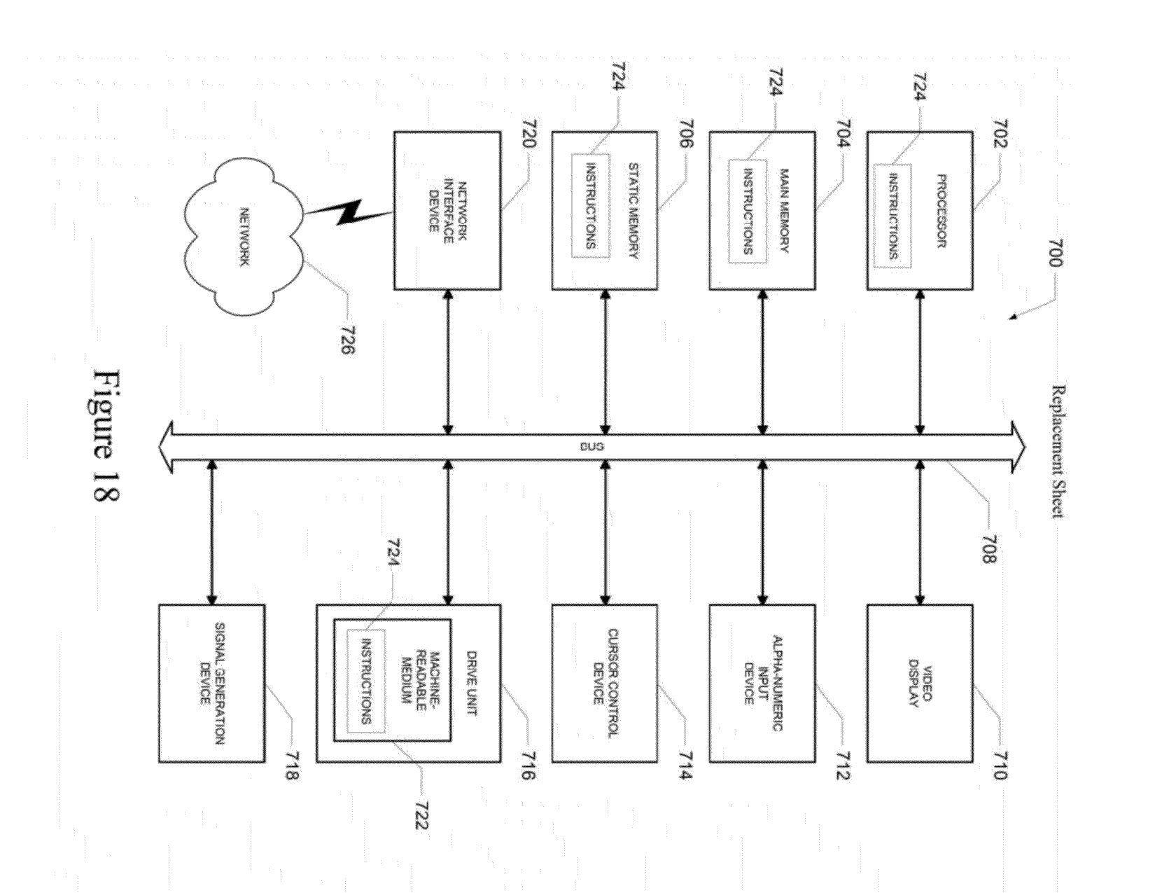

FIG. 18 shows a diagrammatic representation of machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a data processor 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a non-transitory machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single non-transitory medium or multiple media (e.g., a centralized or distributed database, and/or associated caches and servers) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader, to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method, including:
providing, by use of a data processor, a user interface to enable a user to specify a plurality of channels of interest, each channel of the plurality of channels of interest representing a particular source of content accessible via a data network, the user interface further enabling the user to provide authentication credentials for each channel of the plurality of channels of interest;
using the authentication credentials to automatically collect channel data from each of the plurality of channels of interest, the channel data including posts data, subscriber data, and subscriber activity data from each channel;
augmenting the channel data with data collected from other content sources;
processing the augmented channel data to produce an engagement score, the engagement score representing a degree to which a plurality of subscribers are involved in subscriber activity at the plurality of channels of interest; and
presenting at least a portion of the processed augmented channel data and the engagement score to the user in one or more reports.

2. (canceled)

3. The method as claimed in claim 1 wherein the subscriber data includes identities. and data associated with subscribers who have subscribed to a particular channel.

4. The method as claimed in claim 1 wherein the subscriber activity data includes clicks, click-throughs, ‘likes’, ‘shares’, ‘retweets’, comments, and mentions that are related to input provided by particular subscribers on a corresponding channel.

5. The method as claimed in claim 1 wherein the authentication credentials enable access to a user account on a corresponding channel of interest.

6. The method as claimed in claim 1 wherein the other content sources include Klout.com, Bitty, Rapleaf.com, Ow.ly, and Awe.sm.

7. The method as claimed in claim 1 wherein the engagement score includes data indicative of a quantity of actions performed by a particular subscriber at a particular channel over a given period of time.

8. The method as claimed in claim 1 wherein the engagement score includes data indicative of a quantity of actions performed by a plurality of subscribers combined over the channels of interest over a given period of time.

9. The method as claimed in claim 1 wherein the engagement score includes data indicative of a quantity of actions performed by a plurality of subscribers relative to a particular content item at a particular channel.

10. The method as claimed in claim 1 wherein the engagement score includes data indicative of a quantity of actions performed by a plurality of subscribers relative to a plurality of content items at a plurality of channels.

11. A system, comprising:
a data processor;
a database, in data communication with the processor, for storage of content channel information; and
a content channel management module, executable by the processor, to:
provide, by use of the data processor, a user interface to enable a user to specify a plurality of channels of interest, each channel of the plurality of channels of interest representing a particular source of content accessible via a data network, the user interface further enabling the user to provide authentication credentials for each channel of the plurality of channels of interest;
use the authentication credentials to automatically collect channel data from each of the plurality of channels of interest, the channel data including posts data, subscriber data, and subscriber activity data from each channel;
augment the channel data with data collected from other content sources;
process the augmented channel data to produce an engagement score, the engagement score representing a degree to which a plurality of subscribers are involved in subscriber activity at the plurality of channels of interest; and
present at least a portion of the processed augmented channel data and the engagement score to the user in one or more reports.

12. (canceled)

13. The system as claimed in claim 11 wherein the subscriber data includes identities and data associated with subscribers who have subscribed to a particular channel.

14. The system as claimed in claim 11 wherein the subscriber activity data includes clicks, click-throughs, ‘likes’, ‘shares’, ‘retweets’, comments, and mentions that are related to input provided by particular subscribers on a corresponding channel.

15. The system as claimed in claim 11 wherein the authentication credentials enable access to a user account on a corresponding channel of interest.

16. The system as claimed in claim 11 wherein the other content sources include Klout.com, Bit.ly, Rapleaf.com, Ow.ly, and Awe.sm.

17. The system as claimed in claim 11 wherein the engagement score includes data indicative of a quantity of actions performed by a particular subscriber at a particular channel over a given period of time.

18. The system as claimed in claim 11 wherein the engagement score includes data indicative of a quantity of actions performed by a plurality of subscribers combined over the channels of interest over a given period of time.

19. The system as claimed in claim 11 wherein the engagement score includes data indicative of a quantity of actions performed by a plurality of subscribers relative to a particular content item at a particular channel.

20. The system as claimed in claim 11 wherein the engagement score includes data indicative of a quantity of actions performed by a plurality of subscribers relative to a plurality of content items at a plurality of channels.

21. A non-transitory machine-useable storage, medium embodying instructions which, when executed by a machine, cause the machine to:
provide, by use of a data processor, a user interface to enable a user to specify a plurality of channels of interest, each channel of the plurality of channels of interest representing a particular source of content accessible via a data network, the user interface further enabling the user to provide authentication credentials for each channel of the plurality of channels of interest;
use the authentication credentials to automatically collect channel data from each of the plurality of channels of interest, the channel data including posts data, subscriber data, and subscriber activity data from each channel;
augment the channel data with data collected from other content sources;
process the augmented channel data to produce an engagement score, the engagement score representing a degree to which a plurality of subscribers are involved in subscriber activity at the plurality of channels of interest; and
present at least a portion of the processed augmented channel data and the engagement score to the user in one or more reports.
